(19) United States
(12) Patent Application Publication
(10) Pub. No.: US 2002/0055926 A1
(43) Pub. Date: May 9, 2002

(54) Open platform information on universal maps

(76) Inventors: Meir Dan, Tel Aviv (IL); Ofer Tziperman, Kiryat Tivon (IL)

Correspondence Address: FITCH EVEN TABIN AND FLANNERY, 120 SOUTH LA SALLE STREET, SUITE 1600, CHICAGO, IL, 60603-3406, US

(21) Appl. No.: 09/992,631

(22) Filed: Nov. 6, 2001

Related U.S. Application Data
(60) Provisional application No. 60/246,191, filed on Nov. 6, 2000.

(51) Int. Cl. G06F 7/00; G06F 17/00

(52) U.S. Cl. 707/100

(57) ABSTRACT

Systems and methods for an open Geographic Information System are disclosed. In a preferred embodiment, the Geographic Information System includes decentralized contribution of geographic information and/or evaluation of contributions.

This application claims the benefit of U.S. Provisional No. 60/246,191 filed Nov. 6, 2000.

### FIELD OF THE INVENTION

The present invention relates to the field of GIS-Geographic Information Systems.

### BACKGROUND OF THE INVENTION

GIS systems include information related to a specific location, in various contexts. The systems often include layers of information so that users can retrieve desired information independently of other information. For example, some layers may be devoted to the basic map data (such as roads, area outline, demographic and urban data), and other layers to the existence of points of interest, for example specific sites or series of sites such as fuel stations, banks, theaters, scenic routes, etc. within the area outline. Alternatively, the basic map data and information about points of interest may be stored in separate databases.

GIS systems include hardware and software to provide the tools to store, analyze and display information about locations (both basic map data and information about points of interest). The key software components include tools for manipulating the information, a data base management system, tools that create intelligent digital maps that can be analyzed, queried for information or printed for presentation, and a graphical user interface (GUI).

Examples of web sites using GIS systems are www.expedia.com and www.mapquest.com FIG. 1 shows a map of Central Park in New York City from mapquest.

Information about a site or series of sites (pint of interest) at one or more locations are referred to below as a “geographic object” which in general includes the exact location or series of locations (for example using longitude and latitude coordinates) and details about the located site or series of sites.

FIG. 2 shows a prior art GIS system 200. The central part 201 (“central geographic node”) of system 200, includes a retrieval server 234, a map server 214, a geographic object server 216, a map data base 220, and a geographic object database 222.

Map data base 220 includes for example, maps of the entire world including basic map data in various formats such as topographic maps, raster maps in various scales, vector maps, aerial photographs etc. Map server 214 operates a map engine for accessing map data base 220. Geographic object data base 222 includes for example geographic objects and associated information such as advertisements.

Selection of which geographic objects to include in geographic object database 222 is performed centrally by one or more coordinating parties with an interest in collecting one or more specific items of data The parties collect material about geographic objects, analyze the material, and based on the analysis, decide which geographic objects to provide in geographic object data base 222. The collection and update rate is restricted according to the resources allocated for this purpose by the coordinating parties. In addition, the decision of the coordinating parties as to which geographic objects to include is an outcome of their level of interest in a specific subject, and/or their level of economic or other personal motivations.

Geographic object database 222 may be arranged in layers 232 depending on the source of the geographic object, for example yellow pages, video of location, traffic information, data from external data providers, etc. Alternatively, geographic object database 222 may be divided into more than, one database 222 based on the different information sources.

Advertisements may be provided, supported and updated for a charge by an interested party (for example, the owner of the site) in a routine unmediated manner directly to geographic object database 222 and can include text, pictures, etc.

Retrieval of geographic objects is decentralized among end users. Retrieval server 234 of central geographic node 201 is connected to one or more user nodes 210 through a communication medium. 230, such as for example the Internet User interfaces 212 for retrieving, for example browsers, are located at user nodes 210. A user located at user node 210 can request the retrieval of a geographic object which may optionally also retrieve an associated advertisement. The user can request retrieval by defining the location (or radius of search) of the geographic object on the map, for example by inserting an address or coordinates, or by clicking on the map on the icon of a geographic object. A user can also define the location using the data received from a wireless location determination instrument, for example, using certain personal digital assistant (DA) or cellular phones which include both mobile browsers and self location capability. The location can also be defined using the location determination system described in U.S. patent application Ser. No. 09/677,827 to Meir Dan filed on Oct. 2, 2000, details of which are hereby incorporated by reference.

A user can also request retrieval of a geographic object by indicating an object category to which the geographic object belongs, for example landscape, lodging, restaurants, etc. A user can alternatively retrieve the geographic object by defining both an object category and a location.

Retrieval server 234 passes the parameters (location and=or category) for retrieval to geographic object server 216 and/or map server 214. If necessary, map server 214 converts the format of the location input to the format in which map database 220 is arranged, for example to coordinates. Geographic objects from database 222 may be retrieved by geographic object server 216 and passed to map server 214 for incorporation in one or more maps obtained by map server 214 from map database 220. The one or more maps with the incorporated geographic objects may be then passed to retrieval server 234 for presentation to the user. Alternatively. information related to geographic objects may be passed directly by geographic object server 216 to retrieval server 234 for presentation to the user.

It should be evident from the above description, that users can independently retrieve the geographic objects which interests those users but that any additions of geographic objects pass through the coordinating parties, prior to being available to other users.

With the advances in communications and transportation which has rendered the world into “a small village”, the need for a worldwide GIS is increasing; a system that will not be restricted due to its centralization and the resources involved in collecting, analyzing, processing and updating the material.

It is assumed that the community of mankind is the largest information base on places and sites of any kind of type. Despite the characteristic human tendency to share information, the information accumulating at the level of the individual user (through user node 210) is mostly lost, is not documented and is communicated only by means of conversation, story-telling and exchanging experiences. Travel and touring guides are an example of attempts by individuals to store the information gained by their accumulated experience, for the benefit of the public.

With the increased prevalence of mass two-way communication networks such as the Internet, there is an increasing need to share the information accumulated at the user level with the general population around the world, and with virtual community in particular.

There is a need in the art for an open geographic information system, which allows decentralized creation of geographic objects that are then available to other users. There is also a need in the art for an open geographic information system which allow feedback on geographic objects to be available to other users.

### SUMMARY OF THE INVENTION

According to the present invention, there is provided in a Geographic Information System (GIS), that includes a central geographic node containing a map database and configured to communicate through a communication network with a plurality of user nodes, a method for enabling users to manipulate the map database, comprising the steps of: a user node establishing communication through the network with the central geographic node; and the user node providing a geographic object through the network to the central geographic node, thereby causing said geographic object to be associated with at least one map in the map database such that said geographic object is accessible to other user nodes who thereafter communicate with the central geographic node.

The invention further provides in a Geographic Information System (GIS), that includes a central geographic node containing a map database and configured to communicate through a communication network with a plurality of user nodes, a method for enabling users to manipulate the map database, comprising the steps of: a user node establishing communication through the network with the central geographic node; and the user node providing feedback related to a geographic object to the central geographic node through the network thereby causing said feedback to be associated with said geographic object which is associated with at least one map in the map database such that said feedback or a derivative thereof is accessible to other user nodes who thereafter communicate with the central geographic node.

Still further, the invention provides in a Geographic Information System (GIS), s tat includes a central geographic node containing a map database and configured to communicate through a communication network with a plurality of user nodes, a method for enabling users to manipulate the map database, comprising the steps of: the central geographic node receiving a geographic object through the network from a user node; and the central geographic node associating said geographic object with at least one map in said map database, thereby causing said geographic object to be accessible to other user nodes who thereafter communicate with the central geographic node.

Yet further, the invention provides in a Geographic Information System (GIS), that includes a central geographic node containing a map database and configured to communicate through a communication network with a plurality of user nodes, a method for enabling users to manipulate the map database, comprising the steps of: the central geographic node receiving feedback related to a geographic object rough the network from a user node; and the central geographic node associating said feedback with said geographic object which is associated with at least one map in the map database, thereby causing said feedback or a derivative thereof to be accessible to other user nodes who thereafter communicate with the central geographic node.

The invention provides in a Geographic Information System (GIS), that includes a central geographic node containing a map database and configured to communicate through a communication network with a plurality of user nodes, a method for evaluating user contributions, comprising the steps of: the central geographic node receiving at least two contributions related to a same geographic object through the network from user nodes, said geographic object associated with at least one map in the map database; and We central geographic node evaluating said at least two contributions, wherein a result of said evaluating is accessible to other user nodes who thereafter communicate with the central geographic node.

The invention further provides in a Geographic Information System (GIS), that includes a central geographic node containing a map database and configured to communicate through a communication network with a plurality of user nodes, a method for enabling users to retrieve data associated with the map database, comprising the steps of the central geographic node receiving an indication of at least one object category and a rating range through the network from a user node; and the central geographic node providing to the user node at least one geographic object associated with at least one map in the map data base, said at least one geographic object being included in at least one of said at least one object category and having a rating within said rating range.

Still further, the invention provides in a Geographic Information System (GIS), that includes a central geographic node containing a map database and configured to communicate through a communication network with a plurality of user nodes, a method for enabling users to retrieve data associated with the map database, comprising the steps of a user node establishing communication through he network with the central geographic node; and indicating at the user node at least one object category and a rating range; presenting at the user node at least one geographic object associated with at least one map in the map data base, said at least one geographic object being included in at least one of said at least one object category and having a rating within said rating range.

Yet further, the invention provides in a Geographic Information System (GIS), that includes a central geographic node containing a map database and configured to communicate trough a communication network with a plurality of user nodes, a method for enabling users to retrieve data associated with the map database, comprising the steps of: the central geographic node receiving an indication through the network from a user node of a geographic object for which a most popular opinion is requested said geographic object associated with at least one map in the map database; the central geographic node evaluating which opinion associated with said geographic object is most popular; and the central geographic node providing to the user node said evaluated most popular opinion.

The invention provides in a Geographic Information System (GIS), includes a central geographic node containing a map database and configured to communicate trough a communication network with a plurality of user nodes, a method for enabling users to retrieve data associated with Be map database, comprising the steps of: a user node establishing communication through said network with the central geographic node; indicating at the user node a geographic object for which a most popular opinion is requested, said geographic object associated with at least one map in the map database; thereby causing an evaluation of which opinion associated with said geographic object is most popular, and presenting at the user node said evaluated most popular opinion.

The invention further provides a Geographic Information System at a central geographic node configured to communicate through a communication network with a plurality of user nodes, the system comprising: a map database including at least one map; a communication server configured to receive contributions related to geographic objects from the user nodes through the communication network, each said geographic objects associated with at least one of said at least one map; a geographic database configured to store at least said contributions or a derivative thereof; and a geographic object server configured to insert said received contributions or a derivative thereof into said geographic database.

Still further, the invention provides a Geographic Information System at a central geographic node configured to communicate through a communication network with a plurality of user nodes, the system comprising: a map database including at least one map; and an evaluator for evaluating feedback related to geographic objects which are associated with maps in said map database.

Yet further, the invention provides a Geographic Information System at a central geographic node configured to communicate trough a communication network with a plurality of user nodes, the system comprising: a map database including at least one map; a communication server configured to receive object categories and rating ranges related to geographic objects from the user nodes through the communication network, each said geographic object associated with at least one of said at least one map; a geographic database configured to store said geographic objects; and a geographic object server configured to retrieve geographic objects from said geographic database conforming to received object categories and rating ranges for presentation to user nodes.

The invention provides a Geographic Information System at a central geographic node configured to communicate through a communication network with a plurality of user nodes, the system comprising: a map database including at least one map; a geographic database configured to store at least geographic objects and associated opinions on sites represented by said geographic objects; each said geographic object associated with at least one of said at least one map a communication server configured to receive an indication of at least one of said geographic objects for which a most popular opinion of said associated opinions is requested; and an evaluator configured to evaluate which of said opinions is said most popular opinion.

The invention further provides a Geographic Information System at a user node configured to communicate with a central geographic node through a communication network, the system comprising: an input device for inputting data related to a geographic object; and an interface for communicating said inputted data to the central geographic node, hereby allowing said inputted data or a derivative thereof to be accessible to other user nodes.

Yet further, the invention provides in a Geographic Information System (GIS), at includes a central geographic node containing a map database and configured to communicate through a communication network with a plurality of user nodes, a program storage device readable by machine, tangibly embodying a program of instructions executable by the machine to perform method steps for enabling users to manipulate the map database, comprising he steps of: receiving a geographic object through the network from a user node; and associating said geographic object with at least one map in said map database, thereby causing said geographic object to be accessible to other user nodes who thereafter communicate with the central geographic node.

The invention provides in a Geographic Information System (GIS), that includes a central geographic node containing a map database and configured to communicate through a communication network with a plurality of user nodes, a computer program product comprising a computer useable medium having computer readable program code embodied therein for enabling users to manipulate the map database, the computer program product comprising computer readable program code for causing the computer to receive a geographic object through the network from a user node; and computer readable program code for causing the computer to associate said geographic object with at least one map in said map database, thereby causing said geographic object to be accessible to other user nodes who thereafter communicate with the central geographic node.

The invention further provides in a Geographic Information System (GIS), hat includes a central geographic node containing a map database and configured to communicate through a communication network with a plurality of user nodes, a program storage device readable by machine, tangibly embodying a program of instructions executable by the machine to perform method steps for enabling uses to manipulate the map database, comprising the steps of: receiving feedback related to a geographic object through the network from a user node; and associating said feedback with said geographic object which is associated with at least one map in the map database, thereby causing said feedback or a derivative thereof to be accessible to other user nodes who thereafter communicate with the central geographic node.

Still further, the invention provides in a Geographic Information System (GIS), that includes a central geographic node containing a map database and configured to communicate through a communication network wit a plurality of user nodes, a computer program product comprising a computer useable medium having computer readable program code embodied therein for enabling users to manipulate the map database, the computer program product comprising: computer readable program code for causing the computer to receive feedback related to a geographic object through the network from a user node; and computer readable program code for causing the computer to associate said feedback with said geographic object which is associated with at least one map in the map database, thereby causing said feedback or a derivative thereof to be accessible to other user nodes who thereafter communicate with the central geographic node.

Yet further, the invention provides in a Geographic Information System (GIS), that includes a central geographic node containing a map database and configured to communicate through a communication network with a plural of user nodes, a program storage device readable by machine, tangibly embodying a program of instructions executable by the machine to perform method steps for enabling users to retrieve data associated with the map database, comprising the steps of: receiving an indication of at least one object category and a rating range though the network from a user node; and providing to the user node at least one geographic object associated with at least one map in the map data base, said at least one geographic object included in at least one of said at least one object category and having a rating within said rating range.

The invention provides in a Geographic Information System (GIS), that is includes a central geographic node containing a map database and configured to communicate through a communication network with a plurality of user nodes, a computer program product comprising a computer useable medium having computer readable program code embodied therein for enabling users to retrieve data associated with the map database, the computer program product comprising: computer rile program code for causing tie computer to receive an indication of at least one object category and a rating range through the network from a user node; and computer readable program code for causing the computer to provide to the user node at least one geographic object associated with at least one map in the map data base, said at least one geographic object being included in at least one of said at least one object category and having a rating within said rating range.

The invention ether provides in a Geographic Information System (GIS), that includes a central geographic node containing a map database and configured to communicate through a communication network with a plurality of user nodes, a program storage device readable by machine, tangibly embodying a program of instructions executable by the machine to perform method steps for enabling users to retrieve data associated with the map database, comprising the steps of: receiving an indication through the network from a user node of a geographic object for which a most popular opinion is requested, said geographic object associated with at least one map in the map database; evaluating which opinion associated with said geographic object is most popular; and providing to the user said evaluated most popular opinion.

Still further, in a Geographic Information System (GIS), that includes a central geographic node containing a map database and configured to communicate through a communication network with a plurality of user nodes, a computer program product comprising a computer useable medium having computer readable program code embodied therein for enabling users to retrieve data associated with the map database, the computer program product comprising: computer readable program code for causing the computer to receive an indication through the network from a user node of a geographic object for which the a most popular opinion is requested, said geographic object associated with at least one map in the map database; computer readable program code for causing the computer to evaluate which opinion associated with said geographic object is most popular; and computer readable program code for causing the computer to provide to the user node said evaluated most popular opinion.

Yet further, he invention provides in a Geographic Information System (GIS), tat includes a central geographic node conning a map database and configured to communicate through a communication network with a plurality of user nodes, a program storage device readable by machine, tangibly embodying a program of instructions executable by the machine to perform method steps for evaluating user contributions, comprising the steps of: receiving at least two contributions related to a same geographic object through the network from user nodes, said geographic object associated with at least one map in the map Chase; and evaluating said at least two contributions, wherein a result of said evaluating is accessible to other user nodes who thereafter communicate with the central geographic node.

The invention further provides in a Geographic Information System (GIS), that includes a central geographic node containing a map database and configured to communicate through a communication network with a plurality of user nodes, a computer program product comprising a computer useable medium having computer readable program code embodied therein for evaluating user contributions, the computer program product comprising: computer readable program code for causing the computer to receive at least two contributions related to a same geographic object through the network from user nodes, said geographic object associated with at least one map in the map database; and computer readable program code for causing the computer to evaluate said at least two contributions, wherein a result of said evaluating is accessible to other user nodes who thereafter communicate with the central geographic node.

### BRIEF DESCRIPTION OF THE DRAWINGS

For a better understanding, the invention will now be described by way of example only, with reference to the accompanying drawings in which:

FIG. 1 is a map from a prior art geographic information system;

FIG. 2 is a block diagram of a prior art geographic information system;

FIG. 3 is a block diagram of a geographic information system, according to a preferred embodiment of the present invention;

FIG. 4 is a block diagram of an evaluator, according to a preferred embodiment of the present invention ;

FIG. 5 is a screen layout for inputting details about a geographic object, according to a preferred embodiment of the present invention;

FIG. 6 is a screen layout for requesting retrieval of a geographic object, according to a preferred embodiment of the present invention;

FIG. 7 is a screen layout for presenting a retrieved geographic object, according to a preferred embodiment of the present invention;

FIG. 8 is a screen layout for confirming data, according to a preferred embodiment of the present invention;

FIG. 9 is a screen layout displaying a composite rating, according to a preferred embodiment of the present invention;

FIG. 10 is a screen layout for inputting a rating, according to a preferred embodiment of the present invention;

FIG. 11 is a screen layout of retrieved opinions, according to a preferred embodiment of the present invention;

FIG. 12 is a screen layout for inputting an opinion according to a preferred embodiment of the present invention; and

FIG. 13 is a screen layout showing an advertisement with an associated geographic object, according to a preferred embodiment of the present invention.

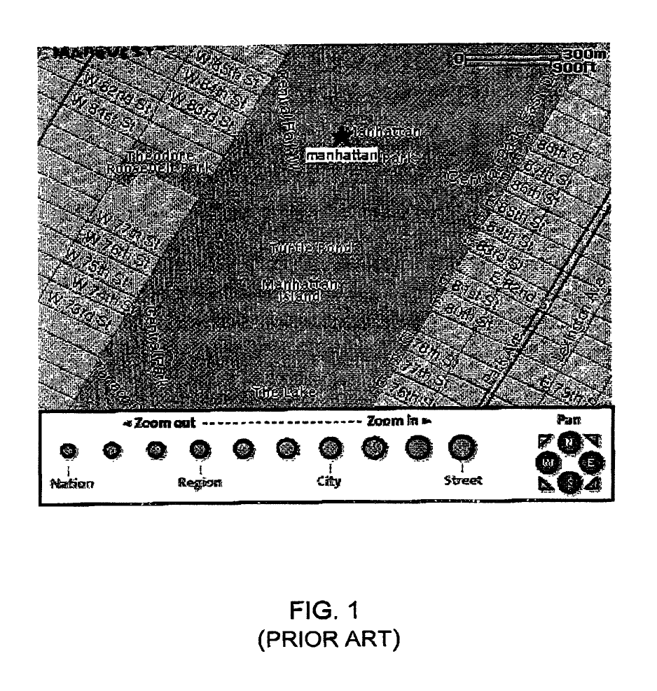

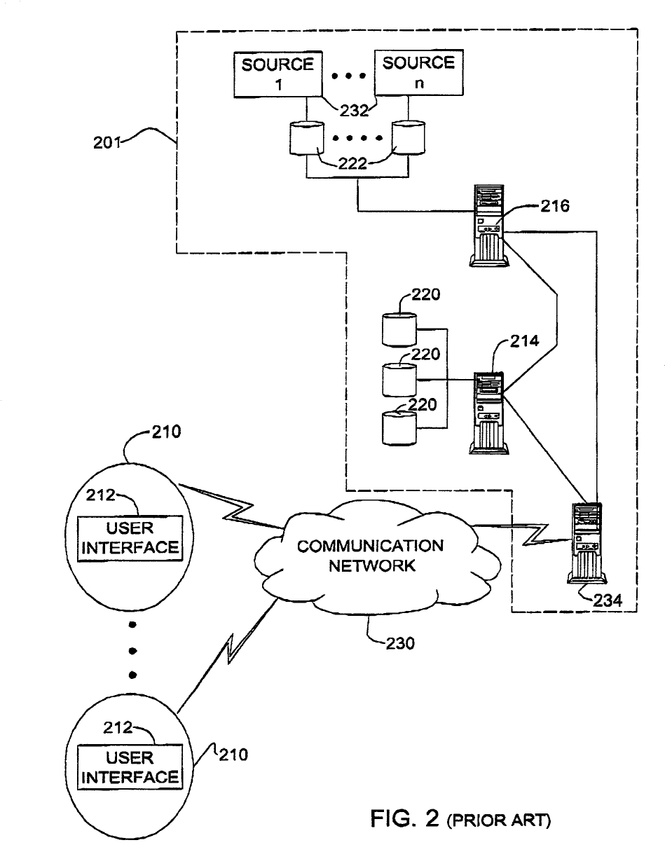

### DETAILED DESCRIPTION OF A PREFERRED EMBODIMENT

For convenience of explanation, the invention is described partly with reference to screen layouts. Those versed in the art will readily appreciate that the invention is by no means bound by the specified screen layouts, their arrangement and or contents.

A preferred embodiment of the present invention relates to an open decentralized geographic information system enabling users to contribute data related to geographic objects (such as geographic objects and feedback on the geographic objects) which will be accessible to other users, without first requiring approval of the contributions by a coordinating party.

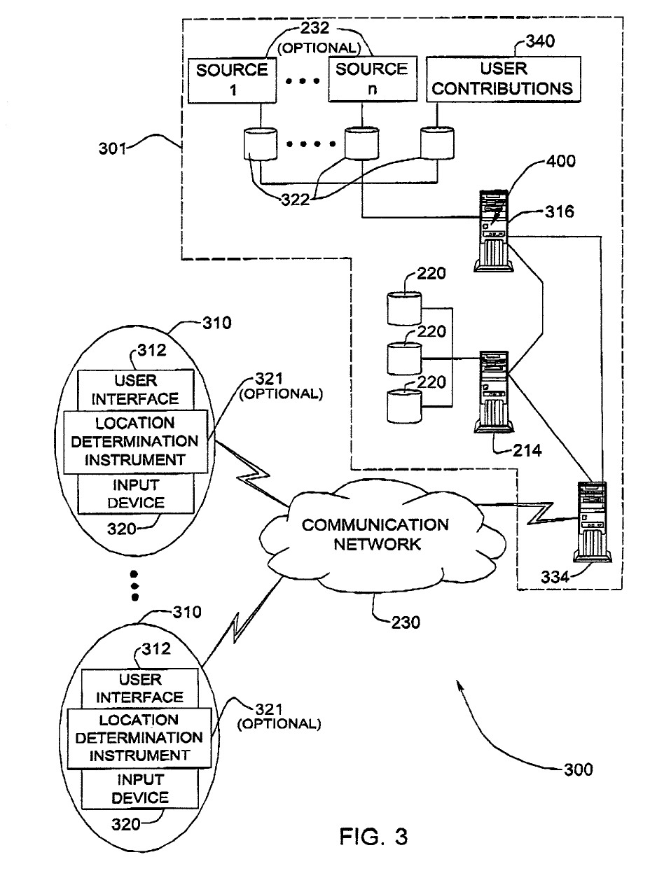

Referring now to the drawings, FIG. 3 illustrates a GIS system 300, according to a preferred embodiment of the present invention. Components of GIS 300 which are identical to GIS 200 are shown with the same numbers. GIS 300 can be used for users contributing, among other data, geographic objects and feedback GIS 300 can also be used to retrieve data related to geographic objects. User nodes 310 are connected to central geographic node 301 through communication medium (i.e. communication network) 230. Communication medium can be for example, the Internet, Public Switched Telephone Network (PSTN), wireless, a combination of any of the above, or any other communication medium.

The term “central” geographic node 301 is used in the logical sense to distinguish between node 301 and user nodes 310. It should be evident that central geographic node 301 may in some preferred embodiments be distributed.

User nodes 310 include an input device 320 for inputting data related to geographic objects, for example details such as name and telephone number, and an interactive interface 312 for communicating with central geographic node 301. It should be evident that different user nodes 310 may include different input devices 320 and/or interactive interfaces 312. Non limiting examples of devices which include input capabilities or input devices include; computers, cellular phones, Personal Digital Assistants “PDA”, telephones, etc. Interface 312 can be for example a graphical user interface (GUI) which allows display capabilities, a textual interface, a voice interface, or any other suitable interface. In the case of communication medium 230 being the Internet, non-limiting examples of interface 312 include a browser, mini-browser, WAP (wireless application protocol) browser, SMS (short message service), and client applications such as locating a point of interest around a user location, navigation to a point of interest, recommended events near user location, etc. In some embodiments, SMS can allow a user access to the internet resources (for both contributions and information retrieval) through an adapter at communication server 334 which translates the SMS message to a user contribution/retrieval transaction over the Internet. User nodes 310 can also optionally include a location determination instrument 321.

The central geographic node 301 of GIS system 300 includes in a preferred embodiment communication server 334, map server 214, geographic object server 316, map database 220, and geographic object database 322. Geographic object database 322 can be for example, an Oracle database adapted to the requirements of the invention. Map database 220 and geographic object database 322 are cross-referenced (associated) by locations for example by coordinates (longitude and latitude). It should be evident that the functionality of map database 220 and geographic object database 322 can be provided by fewer or more databases, for example in some preferred embodiments, geographic object database 322 may be part of map database 220. It should also be evident that the functionality of servers 334, 214, and 316 can be provided by fewer or more servers. The division into databases 220 and 322 and servers 334, 214 and 316, shown in. FIG. 3 is assumed below for ease of explanation.

Communication server 334 allows contributions such as geographic objects and/or feedback to be received from users at user nodes 310, in addition to allowing retrieval of maps, geographic objects, feedback, advertisements etc by users at user nodes 310. (In most cases advertisements are inserted through a centralized mechanism and are not received from user nodes 310.)

As an example, in preferred embodiments where communication medium 230 is the Internet, communication server 334 may host a World Wide Web site and/or a DAWNW based web site on the Internet. The web site(s), can include for example a home page operating as the entry point to the web site, and other pages for contributing or retrieving information related to the geographic information system. The data on the user end may be in HTML, GIF, any appropriate format, or may be converted to any appropriate format. Discussed further below are sample contributing and retrieval screens which are web pages in a preferred embodiment.

Geographic object database 322 includes at least user contributed geographic objects and any associated data. Associated data can be for example feedback, derivatives of feedback, and/or advertisements. Optionally, geographic object database 322 also includes objects not contributed by users (for example from sources such as the yellow pages, videos of the location, traffic information, external providers, etc.). In a preferred embodiment of the present invention, geographic object database 322 includes a separate layer 340 of user contributed geographic objects and associated data with any other layers 232 devoted to geographic objects from other sources. Alternatively a separate database 340 within a series of geographic databases 322 stores user contributed geographic objects and associated data with any other databases 232 within the series devoted to geographic objects from other sources. As another alternative, objects from all data sources including user contributions are stored in the same layer of database 322. For ease of explanation below, user contributions are assumed to be a separate layer 340 of geographic object database 322.

In a preferred embodiment, for each geographic object there is stored within layer 340 one or more of the following associated items: user contributed geographic objects (initial contributions), reliability level of objective data in initial contribution, user contributed opinions on the one or more sites represented by the user contributed geographic object, user contributed votes on those opinions, user contributed ratings towards a general rating for the one or more sites represented by the user contributed geographic object, advertisements related to the user contributed geographic object etc. For any of these items, the data stored may be in the same format as received by communication server 334 or may be in a different format. In addition, for any of these items, the data presented to users may be in the same format as stored or may be in a different format. It should be evident that in alternative preferred embodiments, some or all of the different above mentioned items may be stored in different layers and/or different databases, cross referenced preferably by location (for example by coordinates).

It should be noted that the association of data related to a geographic object such as the geographic object, feedback, derivatives of feedback, advertisements etc., is performed at central geographic node 301. In addition, the association of geographic objects with maps in map database 220 is also performed at central geographic node 301. In many instances different pieces of data related to a specific geographic object are received at different times and/or from different user nodes 310 and must be associated together and with appropriate maps. Association can be achieved for example by storage arrangements (for example: together, contiguous, etc), links, shared identifying variables (for example: same name, coordinates, et for cross-referencing).

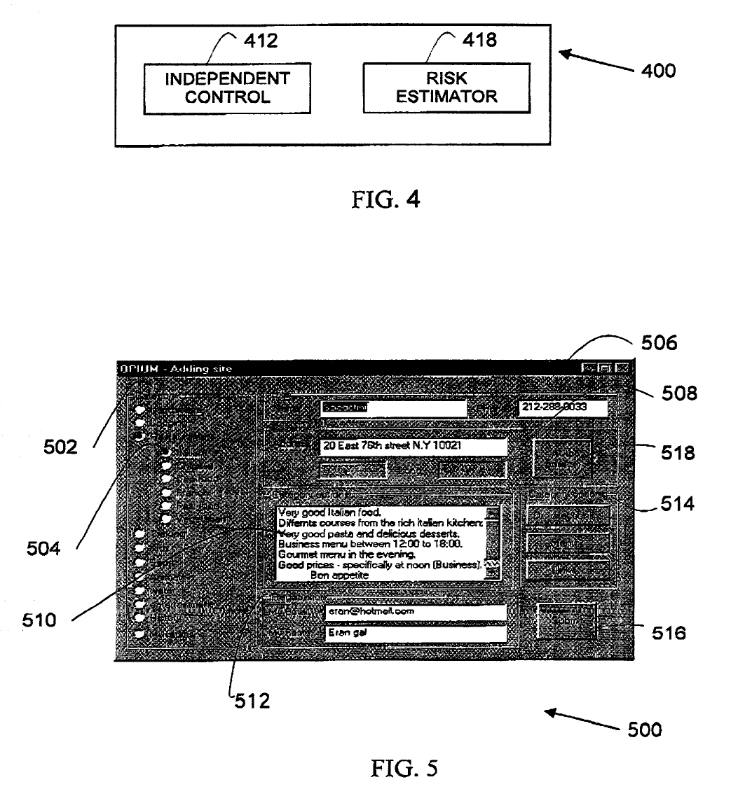

Insertion of user contributions per se is one aspect of the invention. Evaluation of the user contributions is a second distinct aspect of the invention. Central geographic node 301, preferably includes an evaluator 400 for evaluating user contributions to layer 340. In some preferred embodiments, evaluator 400 is a software program, for example included in geographic object server 316. Refer to FIG. 4, which shows sample software components of evaluator 400, according to a preferred embodiment of the present invention. Evaluator 400 preferably includes one or more of the following components for analyzing data, independent control component 412, and risk re-estimating component 318. Independent control component 412 introduces material analysis and weighing regarding the quality of the primary data(initial object contribution) and secondary data (feedback contribution). Risk estimating component 418 introduces reliability grading of the objective primary data. Independent control component 412 and risk estimating component 418 are for example software components. It should be evident that components 412 and 418 may be divided into fewer or more components, and that the chosen division here is for ease of explanation.

Components of central geographic node 301 may be divided among one or more physical locations.

Receiving Contributions

In a preferred embodiment of the present invention, contributions from users, such as geographic objects and feedback, are received by communication server 334. Map server 214 and map database 220 enable synchronization between the different possible formats used by the contributors for specifying the location. For example, if locations are expressed in coordinates within map database 220, a partial or full address received by communication server 334 from a user is converted by map server 214 to coordinates, a click on the map is converted to coordinates, etc. Once the location is or has been converted to the correct format, the contribution is directed to geographic object server 316 for insertion into layer 340 of geographic object database 322.

Geographic Object Insertion

A user may be motivated to insert a geographic object for any number of reasons. A user may be an interested party, such as proprietor of a business who wants to publicize the business by inserting the place on a map, or a user may be an independent party who had a good or bad experience in a certain place, and would like to share it with additional people around the world.

The inserted geographic object represents a point of interest and may be a place or series of places. For example the place may be a beauty spot, or the series of places may form an interesting trip, etc. Other non-limiting examples of what geographic objects can represent include geographic sites, routes, streets, houses, businesses, etc. Geographic objects can represent any object which can be located by fix coordinates (coordinates of a static site), any chain of coordinates or combination of fix and chain, as well as objects with fix address (address of a static site), multiple addresses (collection of addresses forming a route) or a combination of fix and multiple.

Central geographic node 301, allows any user to insert a geographic object (from remote user node 310 via communication medium 230) on a map. Communication server 334 receives the geographic object from a user node 310 and if necessary map server 214 converts the format of the location input. The geographic object is then passed to geographic object server 316 for insertion into layer 340 of object database 340, for example using the location of the site or sites represented by the geographic object as identifying variables. The location can be expressed, for example, in geographic coordinates. The presence of the geographic object will then be indicated on maps retrieved from map database 220, for example by unique symbols or icons at the location of the geographic object. The map, displaying the presence of the geographic object, can be any type of map, in any scale, as long as the area of the map includes the location of the site(s) represented by the geographic object.

A user can contribute the geographic object in any manner consistent with interface 312, for example through audio, textual or graphic means, as long as the user specifies the location of the geographic object.

As an example of the graphical method, the user can request the retrieval of a map including a particular locale. A map including the locale is then retrieved from map database 220 using the map engine of map server 214, passed to communication server 334 and displayed to the user, for example through a browser as interface 312. Assuming that the map display is interactive, the user can then point, for example using a mouse, on the map display to specify the location of a new geographic object.

As another example, the user can specify a location for a new geographic object by inputting an accurate location, for example geographic coordinates or street address.

As another example, the, user can specify the location using location determination insert 321 or the location can be specified using the location determination system of U.S. application Ser. No. 09/677,827 mentioned above.

Once the location of the geographic object is specified, details on the geographic object can be inputted by the user, for example by the user filling in a screen. In some preferred embodiments, the same screen can also be used for specifying the location (for example for inputting coordinates or address) as well as for inputting details.

In a preferred embodiment of the present invention, the details on the geographic object include, possibly among others, classification from an existing classification, name, short description and comments. At least some of the details are preferably in a structured manner and from existing categories. For the sake of example, assume that the details include a category and a subcategory description. Assume also for the sake of example, that existing categories for the category description include, possibly among others, landscape, lodging, restaurants, trekking, kids, sport, animals, water, entertainment, history, and museums. Further assume for the sake of example that subcategories for restaurants include, possibly among others, Italian, Chinese, Sea Food, French, Fast food, and Vegetarian. In this non-limiting example of Spagetini (which extends through the following screens), a user who would like to insert a geographic object about Spagetini, an Italian restaurant, would select restaurants from the existing categories and Italian from the existing subcategories.

Refer to FIG. 5 which shows an example of a screen 500 for inputting details about a geographic object, according to a preferred embodiment of the present invention. The specified geographic object in this case being the exact location of Spagetini, and other details.

Screen 500 includes categories 502 and subcategories 504 for categorizing, analyzing, and retrieving the geographic object. Screen 500 also includes basic information 506 on the geographic object such as name and telephone number, location information 508 such as address and coordinate information, a comments section 510, contributor identification 512 such as name and email address, category options 514 such as driving directions, menu and links, a submit button 516 and an auto-position button 518. Auto position button 518 is used for example in conjunction with location determination instrument 321 and when pressed, returns the coordinates of the current location of the user. In some preferred embodiments, contributor information 512 may be filled in automatically based on previously received information from a user, for example during login.

As mentioned above the layouts of all of the screens presented hereinbelow are examples only and many variations are possible. In some preferred embodiments screen 500 can be varied, for example, by eliminating comments section 510, category options 514 and/or contributor identification 512. Screen 500 in some preferred embodiments can be varied by eliminating subcategories 504 and/or by reducing the number of categories 502. In some preferred embodiments, in order to narrow the scope of a retrieval process of geographic objects (see below) or for any other reason, screen 500 for contributing the geographic objects can include a larger number of categories and/or subcategories.

Once the user submits the geographic object, for example by pressing submit button 516, the geographic object related to Spagetini is saved in layer 340 of geographic object database 322. As mentioned above, geographic objects are associated with maps stored in map database 220, preferably by location for example by coordinates. Therefore, in the future whenever a user requests retrieval of a map which includes Spagetini's location (for example, coordinates N 032 23 32 E 035 16 40) from map database 220, the user will be informed of the presence of a geographic object at that location. The presence of the geographic object can be indicated on a map, for example, by unique symbols or icons. The map, displaying the presence of the geographic object, can be any type of map, in any scale, as long as the area of the map includes that location.

Geographic Object Retrieval

Central geographic node 301 also allows a user to request retrieval of a geographic object. It is assumed that in some instances a user is primarily interested in locating a geographic object within a specific area. For example, a user may be visiting friends and would like to find nearby lodging. In other instances, a user may be primarily interested in geographic objects within an object category. For example, a user may be planning a car-trip with no particular destination and would like to include touring of nature reserves. In still other instances, a user may be primarily interested in geographic objects with a certain rating within an object category. For example, a user may be searching for a highly recommended restaurant for a business lunch.

Therefore in preferred embodiments, central geographic node 301 allows object retrieval for example in one or more of the following ways: definition of a location or range of locations (radius of search), definition of one or more object category and/or subcategory, definition of objects with a certain rating (or rating range) within one or more object category and/or subcategory, or definition of the name of the site or sites represented by the geographic object. Other non listed retrieval methods are also possible within the context of the invention. Retrieval by defining a location or range of locations and/or by a selection of one or more object category/subcategory is discussed above with reference to the prior art. Retrieval by defining the name of the site of sites represented by the geographic object, can be implemented in some preferred embodiments by communication server 334 receiving from a user node 310 the name of the site(s) which is then passed to geographic object server 316, for use in retrieving the geographic object from layer 340. The geographic object is then presented to the user.

In a preferred embodiment of the present invention, a user also has the opportunity to retrieve objects belonging to one or more specified category/subcategory with a specified rating (or range of ratings). In order to implement this preferred embodiment, communication server 334 receives from a user node 310 a specification of a rating or rating range along with an object category or categories (and optionally subcategory or subcategories) which is passed to geographic object server 316, for use in retrieving qualifying geographic objects from layer 340. The geographic object is then presented to the user. If more than one geographic object qualifies, in some preferred embodiment, the list of qualifying objects is presented to the user who can then select one or more of the objects for retrieval. Further below it is discussed how a rating is assigned.

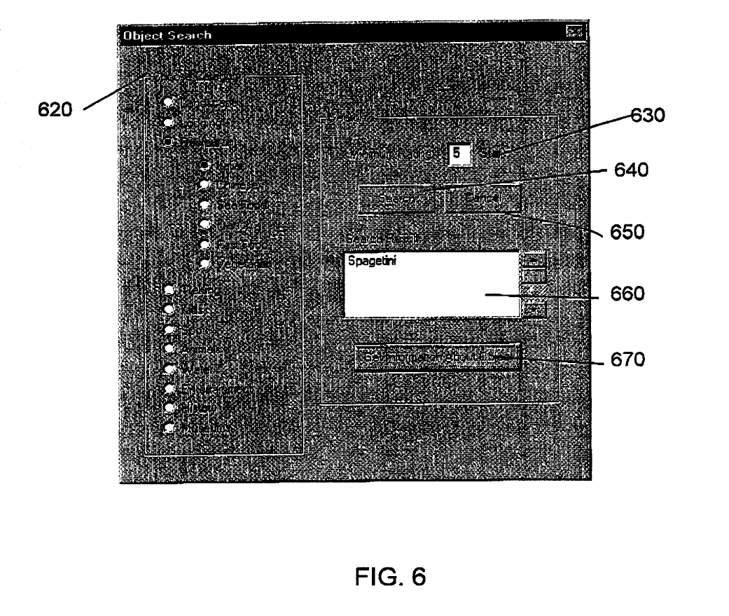

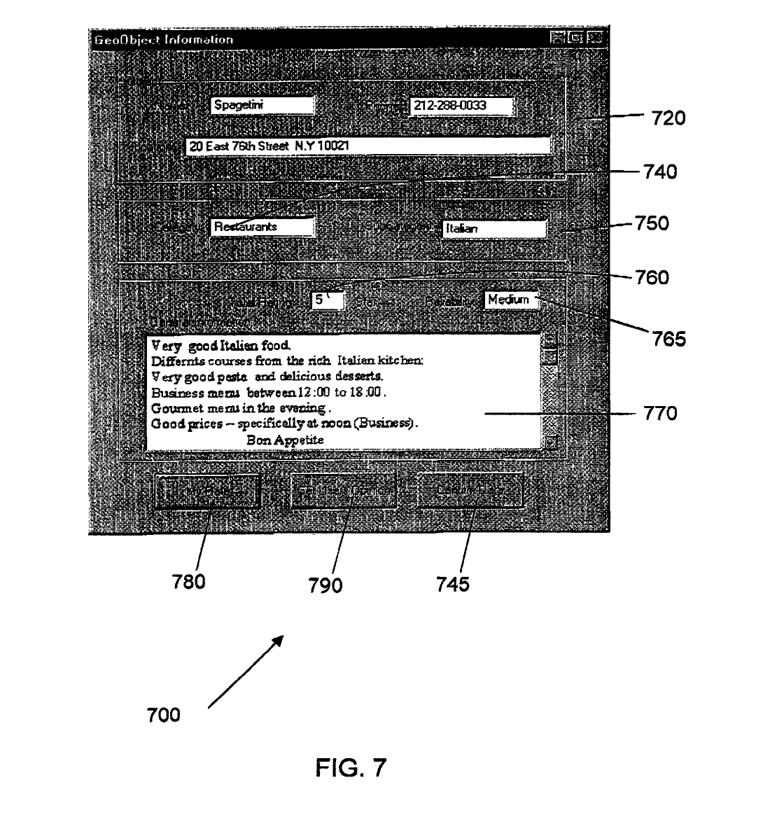

Refer to FIG. 6 which shows a sample screen 600 for requesting retrieval of one or more geographic objects conforming to a specified rating(or rating range and one or more categories (and optionally one or more subcategories), according to a preferred embodiment of the present invention. Screen 600 includes a section. 620 for specifying a desired category or categories, for example restaurants, for the geographic object and optionally a desired subcategory or subcategories, for example Italian. Screen 600 also includes a field 630 for specifying a (composite) rating or rating range, here a minimum rating of 5 stars. Search button 640 allows a search for geographic objects fulfilling the specified criteria. Cancel button 650 allows the search to be canceled. Search result section 660 includes, depending on the preferred embodiment, all or at least one of the qualifying geographic objects. In this example, the geographic object representing Spagetini is returned by the search. Button 670 allows a user to request information about the returned geographic object. If more than one geographic object is returned, one may be selected, for example by highlighting, and information may be requested for the selected one using button 670. In some preferred embodiments, pressing button 670 causes screen 700 (FIG. 7) to appear. In other preferred embodiments, pressing button 670 can lead to a screen allowing the user to specify which information to retrieve (for examples primary contribution, opinions, rating, etc)

Retrieved objects are presented to the user in a manner consistent with interface 312, for example retrieved objects can be displayed graphically, displayed textually or communicated by sound.

FIG. 7 shows a sample screen 700 for presenting a retrieved geographic object to a user, according to a preferred embodiment of the present invention. Section 720 displays basic information about the site (in this example Spagetini) represented by the geographic object, for example name, telephone number and address. Field 740 displays the category of the geographic object and field 750 displays the subcategory, if available. Field 760 displays the (composite) rating, field 765 displays the reliability level, and section 770 displays general information (in some preferred embodiments reflecting comments section 510). It should be evident that less or more information about the site can be displayed on screen 700. Buttons 780, 790, and 795 allow users to perform other functions relating to the displayed geographic object, in this example input a rating, retrieve users opinion, and confirm data, respectively. It should be evident that additional buttons may be added or less buttons may be available on screen 700 in order to further expand or further limit the options available to the user directly from screen 700.

Communication Regarding Geographic Objects

In general, a user retrieves a geographic object at least partially for her own purposes, for example to print out, display, or hear the location and details of the geographic object so that the user can decide whether to visit the site of the geographic object. In some instances, however, the user may decide to actively communicate with others regarding a retrieved geographic object.

It is also possible that a user may decide to actively communicate with other users regarding a previously submitted geographic object, without first retrieving the geographic object.

In a preferred embodiment of the present invention, the active communication is provided through feedback related to the geographic object and/or through chat. Feedback can be provided by users, among other ways, by confirming the objective primary data submitted for the geographic object (for example location and/or the details), by assigning a rating to the site or sites represented by the geographic object, by voting on a previously submitted opinion, and/or by writing an opinion on the site or sites represented by the geographic object.

In a preferred embodiment of the present invention, the actual feedback or a derivative (by-product) of the feedback is made accessible to other users. For example, in some preferred embodiments, the contributed feedback can be made accessible to other users on a separate basis (i.e. feedback from each user is distinguishable from other feedback when presented to other users ), on a synthesized basis (feedback from more than one user is weighed together), or in a manner which includes both separate and synthesized elements. Without necessarily being explicitly disclosed to other users, the contributed feedback can also or alternatively be made accessible to other users by affecting the availability, presentation, or attractiveness to other users of the geographic object or previously submitted feedback about the geographic object.

Confirmation of Geographic Object

In some preferred embodiments of the present invention, a reliability level is assigned to the information relating to geographic objects which should be objective. In some of these preferred embodiments there may be two reliability levels (i.e. likely or less likely to be reliable ) and in some of these preferred embodiments there may be more than two levels.

It is assumed that when a geographic object is initially contributed by a typical user (see above), the objective data (for example location and objective details) is considered to be at the highest risk level (i.e. lowest reliability level), because the information may or may not be reliable. When the geographic object is retrieved by any user, the risk level is also preferably retrieved so that the user knows if the user needs to be cautious in relying on the “objective” information related to the geographic object.

The reliability level is preferably presented to the user in a manner consistent with interface 312.

In some preferred embodiments, a reliability level for all objective information related to a geographic object is presented to a user. For example in screen 700, the medium reliability level of the objective data as a whole is displayed in field 765.

In alternative preferred embodiments, different reliability levels are presented for different groups or for each piece of objective information. For example, the name and location may be noted as being of high reliability and the telephone number of low reliability. La still other alternative embodiments, if there are only two reliability levels, objective information which is considered of a higher reliability level (or less preferably a lower reliability level) may be highlighted on a retrieval screen through bolding, underling, a check mark, etc. If more than two reliability levels exist, different forms of highlighting can be used for different levels of reliability.

The user who retrieves a geographic object may know that some or all of the objective information (i.e. location and objective details) of the geographic object is correct and may desire to confirm some or all of the contents so that other users will be made aware that the information is more reliable. Therefore, when a geographic object is retrieved, there is preferably an option to confirm some or all of the contents, in a manner consistent with interface 312. In some preferred embodiments all the objective information can be confirmed together and in some preferred embodiments each piece of objective information can be confirmed separately.

Refer again to the example of screen 700. Screen 700 includes the following objective information: name, address, telephone number, category, and subcategory. Here the information is shown as being of medium reliability level. Screen 700 also includes subjective information such as general information and a rating which in the preferred embodiment illustrated in FIG. 7 is not be subject to confirmation. In this example a confirmation screen can be brought up by pressing confirm button 795.

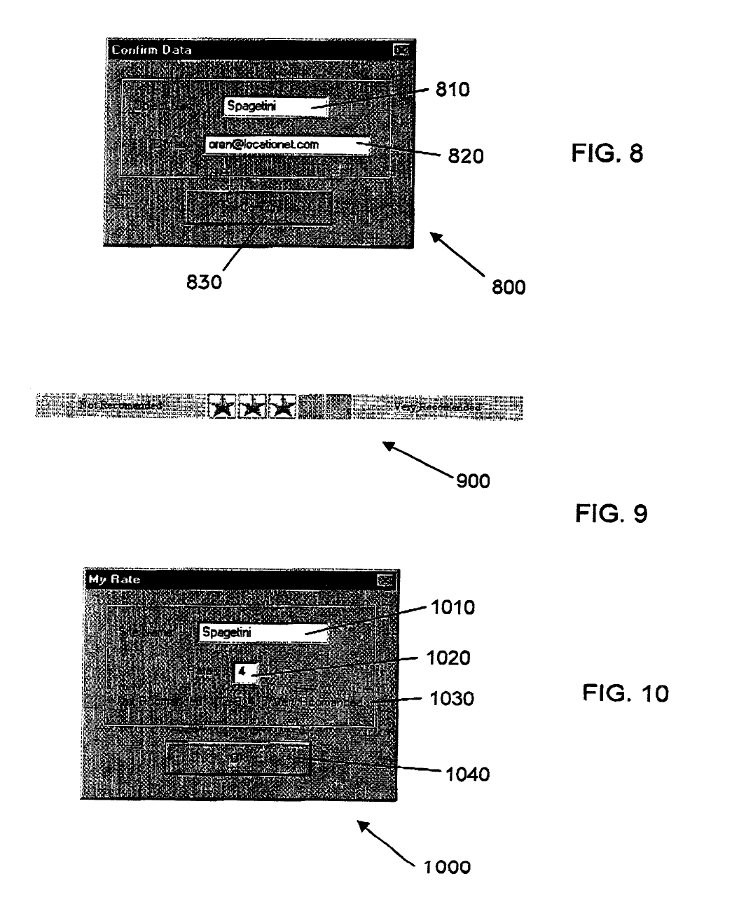

FIG. 8 shows an example of a confirmation screen 800, in accordance with a preferred embodiment of the present invention. In this example it is assumed that all of the objective information related to a geographic object is confirmed together. In field 810 is the name of the geographic object (which is usually also the name of the site or sites represented by the geographic object). The name could have been automatically transferred from a previous screen such as screen 700 or may be filled in by the user. In field 820 is he email address of the user which also can be automatically filled in by the system (based on information previously provided by the user, for example during login) or may be inputted by the user. Confirm button 830 allows the user to confirm the objective data of the geographic object named in field 810.

Once information is confirmed (preferably by an unrelated user to the object contributor, for example from a different email address, telephone number, etc.), the confirmed information moves to a higher reliability level. The changed reliability level, a by-product of the confirmation, is accessible to other users, and the geographic object is assumed to increase in attractiveness.

In some preferred embodiments, certain users are considered system trustees. Objective information related to geographic objects which system trustees insert are given a higher reliability level than if other users inserted the objects. Objective information confirmed by system trustees, in preferred embodiments with more than two reliability levels, moves to a higher reliability level than if other users confirmed the information. System trustees can be for example, owners or managers of the sites represented by the geographic objects.

In preferred embodiments with reliability levels, risk estimating component 418 determines tie reliability level of the objective information related to a geographic object. In some preferred embodiments, each time objective information about geographic objects is inserted or confirmed, estimator 418 calculates or recalculates the reliability level, based on whether a regular user or a system trustee is inserting or confirming the information. In some preferred embodiments, there is a limit to the level of reliability. For example, if a trustee inserts or confirms the information, the information may be considered at the highest level of reliability (i.e. lowest risk level) and no additional confirmations are allowed (for example, confirm button 795 is thereafter left out from screen 700). The determined reliability level for each piece of objective information related to a geographic object or for all objective information as a whole related to a geographic object is preferably stored along with the associated geographic object in layer 340 of geographic object data base 322. The determined reliability level is therefore preferably retrieved each time the associated geographic object is retrieved.

General Rating for a Geographic Object

In some preferred embodiments of the present invention, a user can cause the calculation of a general rating for the geographic object by independent control component 312. The calculation of a general (composite) rating may be performed automatically with the retrieval of the associated geographic object or may be requested separately.

In preferred embodiments where the general rating is calculated automatically with the retrieval of the associated geographic object, the general rating is provided to the user in a way suited to interface 312 along with the geographic object

For example the general rating may be shown on a retrieval screen such as field 760 of screen 700, or voiced for example after the name of the site represented by the geographic object is voiced.

In preferred embodiments where calculation of the general rating is requested separately, a user may be able to request calculation and provision of the general rating during or following the process of geographic object retrieval, in a way suitable to user interface 312, for example by pressing a button on a retrieval screen (not shown).

Alternatively, the user has the option of requesting the retrieval of a general to rating without first retrieving the geographic object, in a way suitable to interface 312. The retrieval criteria can in some preferred embodiments be similar to the criteria for retrieval of objects, for example by specifying a location or range of locations, specifying one or more categories and/or subcategories, specifying a name, and/or specifying one or more categories/subcategories with a certain rating (or rating range), in addition to indicating a desire to retrieve a general rating rather than the geographic object.

The maximum rating can vary in different preferred embodiments, so that the rating can range for example from 1 to 5, from 1 to 10, from 1 to 100, etc.

FIG. 9 shows a sample screen 900 for displaying the general rating independently of other information related the geographic object, according to a preferred embodiment of the present invention. In this example, the star rating system ranges from one star (not recommended) to five stars (highly recommended), with Spagetini receiving a general rating of three stars out of five.

In some preferred embodiments, layer 340 of geographic object database 322 stores individually inputted ratings for each associated geographic object. Each time calculation of the general rating is performed, the individual inputted ratings are retrieved from layer 340 by geographic object server 316. Independent control component 412 weighs the ratings and calculates a (general) composite rating, for example a weighted average rating, from the retrieved individual inputted ratings. The composite rating is passed to communication server 334 for presentation to the user in, a way appropriate with interface 312.

In some preferred embodiments, if a weighted average is desired for the composite rating and if all inputted ratings are equally weighted, then instead of storing each inputted rating separately in layer 340, running totals of the inputted ratings and die number of voters can instead be stored. For example, if three voters rated a site or sites represented by the geographic object with 2 stars, 3 stars, and 4 stars then the running total rating would be 9 stars. In this case, running totals of inputted ratings and number of voters are retrieved by geographic object server 316. For the composite rating, independent control component 412 calculates an average Is by dividing the running total of the inputted ratings by the number of voters, in this example 9/3, which gives a rating of 3 stars.

In some preferred embodiments a user has an option of assigning her rating which will be used for calculating the general rating, in accordance with user interface 312.

FIG. 10 shows an example of a screen 1000 used for inputting (assigning) a rating, according to a preferred embodiment of the present invention Screen 1000 includes field 1010 for the name of the geographic object, usually the name of the site or sites represented by the geographic object, field 1020 for a user assigning a rating, section 1030 for providing information to the user such as the appropriate rating scale, and button 1040 for a user submitting the rating.

In a preferred embodiment, each time another user assigns his rating, the rating is received by communication server 334 and passed to geographic object server 316 which stores the rating in the entry for the associated geographic object in layer 340 (either individually or as part of the total, as explained above). If running totals are kept, then independent control component 412 may also include a simple counter to add the inputted rating to the earlier total rating and increment the number of rating voters stored, for example, in the entry of the associated geographic object.

A user may indicate that she wishes to add her rating about a geographic object, for example by pressing a button on a retrieval screen (for example button 780 on screen 700) or on a composite rating screen (not shown in FIG. 9). Alternatively, the user has the option of contributing her rating about a geographic object without first retrieving the composite rating or geographic object, for example by specifying a location of the geographic object in one of the ways discussed above for geographic object insertion in conjunction with specifying a desire to input her rating in a manner consistent with interface 312, or alternatively by specifying the name of the site or sites represented by the geographic object and the desire to input her rating.

Because the contributed rating (feedback) of the user impacts the composite rating, the composite rating is a by-product of die contributed rating. The composite rating as discussed above is accessible to other users.

Opinions on a Geographic Object

In some preferred embodiments of the present invention, a user can request retrieval of some or all of the opinions on a site or sites represented by the geographic object. For example, a user may request retrieval of all opinions or just the most popular opinion. As mentioned above, opinions are preferably stored with the associated geographic object in layer 340 of geographic object database 322. Preferably opinions includes the date of the opinion and possibly the contributor.

The opinions are retrieved by geographic object server 316. Retrieved opinions are provided to a user in a form consistent with interface 312 by communication server 334.

In some preferred embodiments, a user may be able to request retrieval of opinions by pressing a button on a geographic object retrieval screen, for example button 790 of screen 700, causing opinions to be presented to the user in an opinion screen. In other preferred embodiments, a user can retrieve opinions even without first retrieving the object. The opinion retrieval criteria can in some embodiments be similar to the criteria for retrieval of objects, for example by specifying a location or range of locations, specifying one or more categories and/or subcategories, specifying the name of the site or sites represented by the geographic object, and/or specifying one or more categories/subcategories with a certain rating (or rating range), in addition to indicating in a manner consistent with interface 312 a desire to retrieve opinions (or a subset of opinions) rather than the geographic object

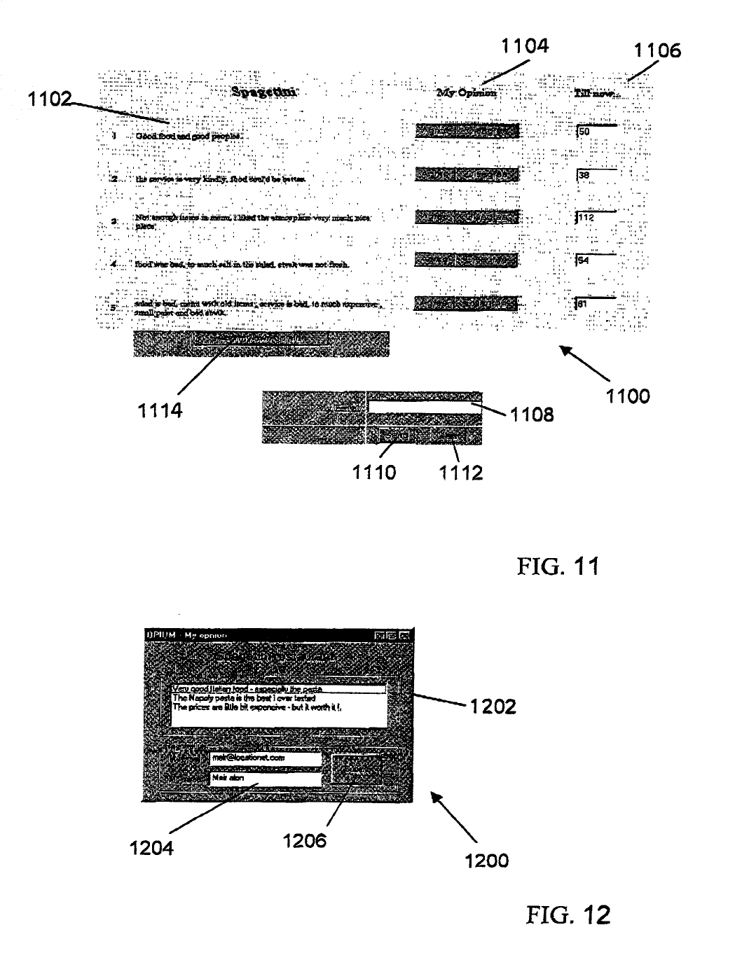

FIG. 11 shows a sample screen 1100 of retrieved opinions, according to a preferred embodiment of the present invention Opinions are listed in section 1102. In some preferred embodiments the date of the opinion is also listed to enable the retrieving user to gauge the pertinence of the opinion (not shown in FIG. 11). In some preferred embodiments of the present invention, a user who retrieves he opinions has the option to actively communicate his feelings either by voting on an existing opinion (for example, “for” or “against”) or submitting his own opinion.

In the preferred embodiment shown in FIG. 11, the opinions are listed in section 1102 in descending order of popularity. For example, in some preferred embodiments the opinion which had the most users vote “for” is listed at the top and the opinion which had the most users voted “against” is listed at the bottom. As another example, in other preferred embodiments the opinion which bad the highest percentage of “for” votes out of a total of users voting about the opinion is listed at the top, and the opinion with the highest percentage of “against” votes out of a total of users voting about the opinion is listed at the bottom.

In some preferred embodiments all of the opinions for an associated geographic object may be stored in layer 340 of geographic object database 322 in order of popularity. In other preferred embodiments, the opinions may be stored in another order and only sorted by popularity prior to being provided to the user.

In some preferred embodiments the total votes “for” and “against” an opinion are stored in layer 340 of geographic object database 322, preferably along with the associated opinions. Alternatively, the total number of voters on an opinion and either the total votes “for” or “against” the opinion are stored. The voting statistics on opinions are preferably retrieved by geographic object server 316 when the corresponding opinions are retrieved so that independent control element 412 can weigh the statistics and sort the retrieved opinions. For example, if the votes “for” and “against” are retrieved, independent control element 412 can calculate the total voters per opinion by summing the “for” and “against” votes and can also sort the voting results in order (either by absolute number of votes or by percentage as explained above). Opinions can then be displayed or otherwise provided to the user (depending on interface 312) in a sorted order consistent with the voting results.

Alternatively, if the opinions are stored in a sorted order in layer 340 of database 322, independent control element 412 may perform sorting of the opinions for a geographic object only when an additional vote “for” or “against” any of the opinions on the geographic object is received.

In the preferred embodiment shown in FIG. 11, screen 1100 has a section 1104 including a “for” and “against” button corresponding to each opinion. A user votes “for” or “against” an opinion by pressing the appropriate button Section 1106 shows the number of voters for each corresponding opinion. Section 1108 identifies the voter, and a send button 1110 causes the vote(s) to be submitted or alternatively a clear button 1112 causes the vote(s) to be cleared. The submitted votes are passed by communication server 334 to geographic object server 316. For example, if a vote is “for”, independent control element 412 can increase the counter of “for” votes and total votes and depending on the embodiment resort the opinions. The new totals for the “for” votes, and depending on the embodiment total votes, are preferably stored in the entry for the associated geographic object in layer 340 of geographic object database 322.

In some preferred embodiments, screen 1100 can be varied to display the number of “for” and/or “against” votes for each opinion.

Because the vote (feedback) of the user “for” or “against” affects the sorted order that opinions are presented to users, the sorted order is a by-product of the vote that is accessible to other users.

As mentioned above, in some preferred embodiments a user also can request retrieval only of the most popular opinion. For example, button 790 can lad to another screen in which the user states whether he wants all or only the most popular opinion. If the user requests only the most popular opinion, screen 1100 can then be modified to include only the first row of sections 1102,1104 and 1106 (assuming opinions sorted by popularity and first row contains data related to the most popular opinion).

A user can instead of or in addition to voting for previously submitted opinions, contribute his own opinion to be stored in layer 340 of geographic object database 322 and thus be accessible to other users.

In a preferred embodiment, a user can indicate that he wishes to contribute his own opinion during retrieval of the associated geographic object or the associated opinions. For example, pressing button 1114 on screen 1100, or a button (not shown) on screen 700 can cause a screen for input an opinion to be displayed.

Alternatively, in a preferred embodiment of the present invention, a user also has the option of inserting an opinion on a site or sites represented by a geographic object, even without first retrieving an the geographic object and/or previously submitted opinions. In some preferred embodiments the insertion of an opinion without first retrieving the associated geographic object or previously submitted opinions can be performed by specifying a location in a manner similar to the insertion of a geographic object, and indicating in a way consistent with interface 312 a desire to insert an opinion rather than a geographic object. Alternatively, the user can specify the name of the site or sites represented by the geographic object and the desire to insert an opinion. The opinion can then be inputted, for example using an opinion input screen.

FIG. 12 shows a sample screen for inputting an opinion, according to a preferred embodiment of the present invention. Screen 1200 includes section 1202 for writing the opinion, section 1204 for signing the opinion, and button 1206 for submitting the opinion.

The contributed opinion is preferably limited in length and signed by user details, as defined. For example the signature can include name of opinion contributor and his email address. The date of contribution is also preferably stored.

As mentioned above, the contributed opinion (feedback) is accessible to other users.

Chat

In a preferred embodiment of the present invention, users who simultaneously access the same geographic object (either for contributing or retrieving data related to the geographic object) are able to chat simultaneously, share impressions, and ask questions about the geographic object.

Advertisement

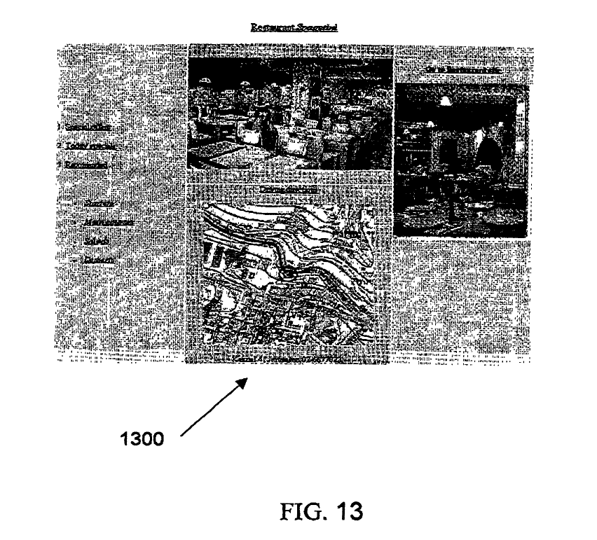

Advertisements have been discussed above with reference to the prior art. FIG. 13 shows an example of an advertisement retrieved along with the geographic object.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

While the invention has been described with respect to a limited number of embodiments, it will be appreciated that many variations, modifications and other applications of the invention may be made.

1. In a Geographic Information System (GIS), that includes a central geographic node containing a map database and configured to communicate through a communication network with a plurality of user nodes, a method for enabling users to manipulate the map database, comprising the steps of:
a user node establishing communication through the network with the central geographic node; and
the user node providing a geographic object through the network to the central geographic node, thereby causing said geographic object to be associated with a least one map in the map database such that said geographic object is accessible to other user nodes who thereafter communicate with the central geographic node.

2. The method of claim 1, wherein said step of providing includes the steps of:
inputting at the user node data related to said geographic object.

3. The method of claim 2, wherein said step of providing said geographic object further includes prior to the step of inputting data the steps of:
viewing at the user node at least one of said at least one map; and
clicking on said at least one of said at least one map at a location, thereby causing said location on said at least one map to be associated with said geographic object.

4. The method of claim 2, wherein said step of providing said geographic object further includes prior to the step of inputting data the steps of:
receiving at the user node a location using a location determination instrument and providing said location to the central geographic node, thereby causing said location on said at least one map to be associated with said geographic object.

5. The method of claim 2, wherein said step of inputting data includes the step of inputting a location for said geographic object, thereby causing said location on said at least one map to be associated with said geographic object.

6. The method of claim 5, wherein said data includes at least one selected from the group of: address and coordinates.

7. The method of claim 2, wherein said data includes at least one selected from the group of: category, subcategory, name, telephone number, and comments.

8. The method according to claim 1, further comprising the steps of:
a second user node establishing communication through the network with the central geographic node; and
selecting at the second user node said geographic object and providing feedback related to said geographic object to the central geographic node through the network; thereby causing said feedback to be associated with said geographic object such that said feedback or a derivative hereof is accessible to other user nodes thereafter communicating with the central geographic node.

9. The method of claim 8, wherein said step of providing feedback includes the step of:
voting on an opinion about at least one site represented by said geographic object, hereby causing a sorting of an order of opinions related to said geographic object, such tat said sorted order, a derivative of said feedback, is accessible to other user nodes thereafter communicating with the central geographic node.

10. The method according to claim 8, wherein said feedback is an opinion about at least one site represented by said geographic object, further comprising the steps of:
a third user node establishing communication through the network with the central geographic node;
casting a vote at the third user node about said opinion; and
said casting of a vote causing a sorting of said opinion and other opinions according to popularity.

11. The method of claim 8, wherein sad step of providing feedback includes the step of confirming at least part of the data related to said geographic object, thereby causing a reduction in a risk level of any confirmed data, such that said reduced risk level, a derivative of said feedback, is accessible to other user nodes thereafter communicating with the central geographic node.

12. The method of claim 8, wherein said step of providing feedback includes the step of assign a rating to at least one site represented by said geographic object, thereby causing a weighing of said rating with any previously received ratings in order to calculate a composite rating, such that said composite rating a derivative of said feedback, is accessible to other user nodes thereafter communicating with the central geographic node.

13. In a Geographic Information System (GIS), that includes a central geographic node containing a map database and configured to communicate trough a communication network with a plurality of user nodes, a method for enabling users to manipulate the map database, comprising the steps of:
a user node establishing communication through the network with the central geographic node; and
the user node providing feedback related to a geographic object to the central geographic node through the network, thereby causing said feedback to be associated with said geographic object which is associated with at least one map in the map database such that said feedback or a derivative thereof is accessible to other user nodes who thereafter communicate with the central geographic node.

14. The method of claim 13, wherein said step of providing feedback includes the step of providing an opinion about at leas one site represented by said geographic object.

15. The method of claim 14, wherein said opinion includes details of a user at the user node and a date of said opinion.

16. The method of claim 13, wherein said step of providing feedback includes the step of: voting at the user node on an opinion about at least one site represented by said geographic object, thereby causing a sorting of an order of opinions related to said geographic object such tat sad sorted order, a derivative of said feedback, is accessible to other user nodes thereafter communicating with the central geographic node.

17. The method of claim 13, wherein said step of providing feedback includes the step of: confirming at the user node at least part of the data related to said geographic object, thereby causing a reduction in a risk level of any confirmed data, such that said reduced risk level, a derivative of said feedback, is accessible to other user nodes thereafter communicating with the central geographic node.

18. The method of claim 13, wherein said step of providing feedback includes the step of assigning at the user node a rating to at leas one site represented by said geographic object thereby causing a weighing of said rating with any previously received ratings in order to calculate a composite rating, such that said composite rating, a derivative of said feedback, is accessible to other user nodes thereafter communicating with the central geographic node

19. In a Geographic Information System (GIS), that includes a central geographic node containing a map database and configured to communicate through a communication network with a plurality of user nodes, a method for enabling users to manipulate the map database, comprising the steps of:
the central geographic node receiving a geographic object through the network from a user node; and
the central geographic node associating said geographic object with at least one map in said map database, thereby causing said geographic object to be accessible to other user nodes who thereafter communicate with the central geographic node.

20. In a Geographic Information System (GIS), that includes a central geographic node containing a map database and configured to communicate through a communication network with a plurality of user nodes, a method for enabling users to manipulate the map database, comprising the steps of:
the central geographic node receiving feedback related to a geographic object through the network from a user node; and
the central geographic node associating said feedback with said geographic object which is associated with at least one map in the map database, thereby causing said feedback or a derivative thereof to be accessible to other user nodes who thereafter communicate with the central geographic node.

21. The method of claim 20, wherein said feedback is an opinion about at least one site represented by said geographic object.

22. The method of claim 20, wherein said step of associating includes the step of: the central geographic node changing the reliability level of data related to said geographic object based on said feedback, thereby causing said changed reliability level, a derivative of the feedback, to be accessible to other user nodes who thereafter communicate with the central geographic node.

23. The method of claim 22, wherein said feedback received from the user node confirms at least part of data related to said geographic object.

24. The method of claim 20, wherein said step of associating includes the step of: the central geographic node weighing said feedback with any other previously received feedback about at least one site represented by said geographic object, thereby causing results of said weighing, a derivative of said feedback, to be accessible to other user nodes who thereafter communicate with the central geographic node.

25. The method of claim 24, wherein said feedback and said any other previously received feedback are ratings for said at least one site, said step of weighing including the step of: the central geographic node calculating a composite rating thereby causing said composite rating, a derivative of the feedback, to be accessible to other user nodes who thereafter communicate with the central geographic node.

26. The method of claim 24, wherein said feedback and said any other previously received feedback are votes on opinions about at least one site represented by sad geographic objet said step of weighing including the step of :the central geographic node sorting an order of said opinions based on said votes, thereby causing said sorted order, a derivative of the feedback, to be accessible to other user nodes thereafter communicating with the central geographicnode.

27. In a Geographic Information System (GIS), that includes a central geographic node containing a map database and configured to communicate rough a communication network with a plurality of user nodes, a method for evaluating user contributions, comprising the steps of:
the central geographic node receiving at least two contributions related to a same geographic object through the network from user nodes, said geographic object associated with at least one map in the map database; and
the central geographic node evaluating said at least two contributions, wherein a result of said evaluating is accessible to other user nodes who thereafter communicate with the central geographic node.

28. The method of claim 27, wherein at least one of said at least two contributions is a geographic object and at least one of sad at least two contributions is a confirmation of data related to said geographic object, said step of evaluating including the step of: changing a reliability level of said data based on said confirmation, wherein said changed reliability level is accessible to other user nodes who thereafter communicate with the central geographic node.

29. The method of claim 27, wherein at least two of said at leas two contributions are at least two opinions on at least one site represented by a geographic object and at least one of sad at least two contributions is at least one vote about at least one of said at leas two opinions, said step of evaluating including the step of: sorting an order of said at least two opinions based on said at least one vote, wherein said sorted order is accessible to other users who thereafter communicate with the central geographic node.

30. The method of claim 27, wherein at least two of said at least two contributions are at least two ratings on at least one site resented by a geographic object, said step of evaluating including the step of: calculating a composite rating based on said at least two ratings, wherein said composite rating is accessible to other user nodes who thereafter communicate with the central geographic node.

31. In a Geographic Information System (GJS), that includes a central geographic node containing a map database and configured to communicate through a communication network with a plurality of user nodes, a method for enabling users to retrieve data associated with the map database, comprising the steps of:
the central geographic node receiving an indication of at least one object category and a rating range through the network from a user node; and
the central geographic node providing to the user node at least one geographic object associated with at least one map in the map data base, said at least one geographic object being included in at least one of said at least one object category and having a rating within said rating range.

32. In a Geographic Information System (GIS), that includes a central geographic node containing a map database and configured to communicate through a communication network wit a plurality of user nodes, a method for enabling users to retrieve data associated with the map database, comprising the steps of:
a user node establishing communication through the network with the central geographic node; and
indicating at the user node at least one object category and a rating range;
presenting at the user node at least one geographic object associated with at least one map in the map data base, said at least one geographic object being included in at least one of said at least one object category and having a rating within said rating range.

33. In a Geographic Information System (GIS), that includes a central geographic node containing a map database and configured to communicate through a communication network with a plurality of user nodes, a method for enabling users to retrieve data associated with e map database, comprising the steps of:
the central geographic node receiving an indication through the network from a user node of a geographic object for which a most popular opinion is requested, said geographic object associated with at least one map in the map database;
the central geographic node evaluating which opinion associated with said geographic object is most popular; and
the central geographic node providing to the user node said evaluated most popular opinion.

34. The method of claim 33, wherein said step of evaluating includes the step of: the central geographic node comparing a number of votes received for each opinion from user nodes.

35. In a Geographic Information System (GIS), that includes a central geographic node containing a map database and configured to communicate through a communication network with a plurality of user nodes, a method for enabling users to retrieve data associated wit the map database, comprising the steps of:
a user node establishing communication through said network with he central geographic node;
indicating at the user node a geographic object for which a most popular opinion is requested, said geographic object associated with at least one map in the map database; thereby causing an evaluation of which opinion associated with said geographic object is most popular; and
presenting at the user node said evaluated most popular opinion.

36. A Geographic Information System at a central geographic node configured to communicate through a communication network with a plurality of user nodes, the system comprising:
a map database including at least one map;
a communication server configured to receive contributions related to geographic objects from the user nodes through the communication network, each said geographic objects associated with at least one of said at least one map;
a geographic database configured to store at least said contributions or a derivative thereof; and
a geographic object server configured to insert said received contributions or a derivative thereof into said geographic database.

37. The system of claim 36, further comprising a map server for synchronizing between locations included in said contributions.

38. The system of claim 36, wherein at least one of said contributions is a geographic object.

39. The system of claim 36, wherein at least one of said contributions is feedback related to a geographic object.

40. The system of claim 36, further comprising an independent control element configured to weigh feedback related to geographic objects.

41. The system of claim 36, further comprising a risk estimator configured to estimate the reliability level of at least part of said contributions.

42. A Geographic Information System at a central geographic node, configured to communicate through a communication network with a plurality of user nodes, the system comprising:
a map database including at least one map; and
an evaluator for evaluating feedback related to geographic objects which are associated with maps in said map database.

43. The system of claim 42, wherein said evaluator includes an independent control element configured to weigh said feedback.

44. The system of claim 42, wherein said evaluator included a risk estimator configured to estimate the reliability level of data related to said geographic objects based on said feedback.

45. A Geographic Information System at a central geographic node configured to communicate through a communication network with a plurality of user nodes, the system comprising:
a map database including at least one map;
a communication server configured to receive object categories and rating ranges related to geographic objected from the user nodes through the commination network, each said geographic object associated with at least one of said at least one map;
a geographic database configured to store said geographic objects; and
a geographic object server configured to retrieve geographic objects from said geographic database conforming to received object categories and rating ranges for presentation to user nodes.

46. A Geographic Information System at a central geographic node configured to communicate through a communication network with a plurality of user nodes, the system comprising:
a map database including at least one map;
a geographic database configured to store at least geographic objects and associated opinions on sites represented by said geographic objects; each said geographic object associated with at least one of said at least one map
a communication server configured to receive an indication of at least one of said geographic objects for which a most popular opinion of said associated opinions is requested; and
an evaluator configured to evaluate which of said opinions is said most popular opinion.

47. A Geographic Information System at a user node configured to communicate with a central geographic node through a communication network, the system comprising:
an input device for inputting data related to a geographic object; and
an interface for communicating said inputted data to the central geographic node, thereby allowing said inputted data or a derivative thereof to be accessible to other user nodes.

48. The system of claim 47, wherein said interface is a selected from the group of: browser, mini-browser, WAP browser, SMS, and client applications.

49. The system of claim 47, further comprising a location determination instrument to determine the location of the user node.

50. In a Geographic Information System (GIS), that includes a central geographic node coining a map database and configured to communicate through a communication network with a plurality of user nodes, a program storage device readable by machine, tangibly embodying a program of instructions executable by the machine to perform method steps for enabling users to manipulate the map database, comprising the steps of:
receiving a geographic object through the network from a user node; and
associating said geographic object with at least one map in said map database, thereby causing said geographic object to be accessible to other user nodes who thereafter communicate with the central geographic node.

51. In a Geographic Information System (GIS), that includes a central geographic node containing a map database and configured to communicate through a communication network with a plurality of user nodes, a computer program product comprising a computer useable medium having computer readable program code embodied therein for enabling uses to manipulate the map database, the computer program product comprising:
computer readable program code for causing the computer to receive a geographic object through the network from a user node; and
computer readable program code for causing the computer to associate said geographic object with at least one map in said map database, thereby causing said geographic object to be accessible to other user nodes who thereafter communicate with the central geographic node.

52. In a Geographic Information System (GIS), that includes a central geographic node containing a map database and configured to communicate through a communication network with a plurality of user nodes, a program storage device readable by machine, tangibly embodying a program of instructions executable by the machine to perform method steps for enabling users to manipulate the map database, comprising the steps of:
receiving feedback related to a geographic object through the network from a user node; and
associating said feedback with said geographic object which is associated with at least one map in the map database, hereby causing said feedback or a derivative thereof to be accessible to other user nodes who thereafter communicate with the central geographic node.

53. In a Geographic formation System (GIS), that includes a central geographic node containing a map database and configured to communicate through a communication network with a plurality of user nodes, a computer program product comprising a computer useable medium having computer readable program code embodied therein for enabling users to manipulate the map database, the computer program product comprising:
computer readable program code for causing the computer to receive feedback related to a geographic object trough the network from a user node; and
computer readable program code for causing the computer to associate said feedback with said geographic object which is associated with at least one map in the map database, thereby causing said feedback or a derivative thereof to be accessible to other user nodes who thereafter communicate with the central geographic node.

54. In a Geographic Information System (GIS), that includes a central geographic node containing a map database and configured to communicate trough a communication network with a plurality of user nodes, a program storage device readable by machine, tangibly embodying a program of instructions executable by the machine to perform method steps for enabling users to retrieve data associated with the map database, comprising the steps of:
receiving an indication of at least one object category and a rating range through the network from a user node; and
providing to the user node at least one geographic object associated with at least one map in the map data base, said at least one geographic object being included in at least one of said at least one object category and having a rating within said rating range.

55. In a Geographic Information System (GIS), that includes a central geographic node containing a map database and configured to communicate through a communication network with a plurality of user nodes, a computer program product comprising a computer useable medium having computer readable program code embodied therein for enabling uses to retrieve data associated with the map database, the computer program product comprising:
computer readable program code for causing the computer to received an indication of at least one object category and a rating range through the network from a user node; and
computer readable program code for causing the computer to provide to the user node at least one geographic object associated with at least one map in the map data base, said at least one geographic object being included in at least one of said at least one object category and having a rat within said rating range.

56. In a Geographic Information System (GIS), that includes a central geographic node containing a map database and configured to communicate through a communication network with a plurality of user nodes, a program storage device readable by machine, tangibly embodying a program of instructions executable by the machine to perform method steps for enabling users to retrieve data associated with the map database, comprising the steps of:
receiving an indication through the network from a user node of a geographic object for which a most popular opinion is requested, said geographic object associated with at least one map in the map database;
evaluating which opinion associated win said geographic object is most popular, and
providing to the user said evaluated most popular opinion.

57. In a Geographic Information System (GIS), that includes a central geographic node containing a map database and configured to communicate through a communication network with a plurality of user nodes, a computer program product comprising a computer useable medium having computer readable program code embodied therein for enabling users to retrieve data associated with the map database, the computer program product comprising:
computer readable program code for causing the computer to receive an indication through the network from a user node of a geographic object for which the a most popular opinion is requested said geographic object associated with at least one map in the map database;
computer readable program code for causing the computer to evaluate which opinion associated with said geographic object is most popular; and
computer readable program code for caning the computer to provide to the user node said evaluated most popular opinion.

58. In a Geographic Information System (GIS), that includes a central geographic node containing a map database and configured to communicate through a communication network with a plurality of user nodes, a program storage device readable by machine, tangibly embodying a program of instructions executable by the machine to perform method steps for evaluating user contributions, comprising the steps of:
receiving at least two contributions related to a same geographic object through the network from user nodes, said geographic object associated with at least one map in the map database; and
evaluating said at least two contributions, wherein a result of said evaluating is accessible to other user nodes who thereafter communicate with the central geographic node.

59. In a Geographic Information System (GIS), that includes a central geographic node containing a map database and configured to communicate through a communication network with a plurality of user nodes, a computer program product comprising a computer useable medium having computer readable program code embodied therein for evaluating user contributions, the computer program product comprising:
computer readable program code for causing the computer to receive at least two contributions related to a same geographic object through the network from user nodes, said geographic object associated with at least one map in the map database; and
computer readable program code for causing the computer to evaluate said at least two contributions, wherein a rest of said evaluating is accessible to other user nodes who thereafter communicate with the central geographic node.
